(19) United States
(12) Patent Application Publication
(10) Pub. No.: US 2016/0266313 A1
(43) Pub. Date: Sep. 15, 2016

(54) THERMALLY PRINTED OPTIC CIRCUITS

(71) Applicant: EMPIRE TECHNOLOGY DEVELOPMENT LLC, Wilmington, DE (US)

(72) Inventors: Benjamin William MILLAR, Rosebery, New South Wales (AU); Benjamin Watson BARNES, Thornleigh, New South Wales (AU)

(73) Assignee: EMPIRE TECHNOLOGY DEVELOPMENT LLC, Wilmington, DE (US)

(21) Appl. No.: 15/031,713

(22) PCT Filed: Oct. 22, 2013
(86) PCT No.: PCT/US13/66091

§ 371 Date: Apr. 22, 2016

(51) Int. Cl. G02B 6/13; B29D 11/00; G02B 6/12; G02B 6/132; G02B 6/122

(52) U.S. Cl. CPC G02B 6/13; G02B 6/132; G02B 6/1221; G02B 6/12002; B29D 11/00682; G02B 2006/12069; G02B 2006/12061; G02B 2006/12073; G02B 2006/12104; B29D 11/00663; B29D 11/00721; B29K 2079/08

(57) ABSTRACT

Methods of making optical circuits or waveguides and optical circuits and waveguides made by such methods are disclosed. Optical circuits may include a substrate, a first polymer layer, and a second polymer layer. A first portion of the first polymer layer has a higher refractive index than a second portion of the first polymer layer. Optical waveguides may include a first polymer layer on a surface of a substrate. A first portion of the first polymer layer has a higher refractive index than a second portion of the first polymer layer.

### BACKGROUND

Optical systems are becoming increasingly popular for incorporation into electronic devices due to a need for an increase in communication speed within circuits in the devices. Optical fibers have significant advantages over existing copper wires for high demand applications and long-distance communication. Over time, while optical fibers have become increasingly popular, they have also become more affordable. Thus, there is a high demand for fiber optic circuit boards in the electronics industry.

However, current fiber optic connections are difficult to produce and are not implemented on a large scale. The extrinsic nature of the optical fibers to the structural component of the circuit board and the elasticity of optical fibers means that placement is complex and alignment is often inaccurate. Managing fiber optic connection points and interconnections to multiple optical fibers along with the construction complexity of accurately placing a large number of optical fibers into a functional configuration make it difficult for mass scale manufacturing.

### SUMMARY

In an embodiment, a method of forming an optical circuit may include providing a first polymer layer on a surface of a substrate; heating a first portion of the first polymer layer to a temperature sufficient to increase a refractive index of the first portion such that the first portion has a higher refractive index relative to a second portion of the polymer film, the second portion at least partially surrounding the first portion to form an optical waveguide; and providing a second polymer layer on the first polymer layer.

In an embodiment, a method of making an optical waveguide may include heating a first portion of a first polymer layer to a temperature sufficient to increase a refractive index of the first portion such that the first portion has a higher refractive index relative to a second portion of the polymer, the second portion at least partially surrounding the first portion.

In an embodiment, an optical circuit comprises a substrate having a surface; an optical waveguide comprising a first polymer layer on the surface of the substrate, the first polymer layer comprising a first portion having a higher refractive index than a second portion, the second portion at least partially surrounding the first portion; and a second polymer layer on the first polymer layer.

In a further embodiment, an optical waveguide is comprised of a first polymer layer on a surface of a substrate, the first polymer layer comprising a first portion having a higher refractive index than a second portion, the second portion at least partially surrounding the first portion.

### BRIEF DESCRIPTION OF THE DRAWINGS

FIG. 1 depicts a flowchart of an illustrative method of forming an optical circuit according to an embodiment.

FIG. 2 depicts a flowchart of an illustrative method of making an optical waveguide according to an embodiment.

FIG. 3 depicts heat-affected zones within a polymer layer used to form a waveguide according to an embodiment.

FIG. 4 is a cross-sectional illustration of uncooled and cooled surfaces surrounding the hot contacts of a waveguide during formation according to an embodiment.

FIG. 5A depicts a block diagram of illustrative layers of an optical circuit according to an embodiment.

FIG. 5B depicts a block diagram of an illustrative optical waveguide according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “core layer” refers to any layer of an optical waveguide that transmits light. A “cladding layer” refers to any layer of an optical waveguide that confines light. In an embodiment, a core layer may be at least partially encompassed by a cladding layer.

A “specular reflector” refers to any reflective surface that reflects electromagnetic waves, for example, light, in which the angle of reflection is equal to the angle of incidence.

A “stamp” refers to any device used to transfer heat from a source or pattern to a material surface, such as a polymer or a foil. “Stamping” refers to any operation by which a stamp is used to transfer heat from a source or pattern to a material surface, such as a polymer or a foil.

A “waveguide” refers to a system having a material that provides a path to guide an electromagnetic wave. A waveguide may have, for example and without limitation, a circular or rectangular shape.

A “first polymer layer” refers to a single polymer layer or a plurality of polymer sublayers.

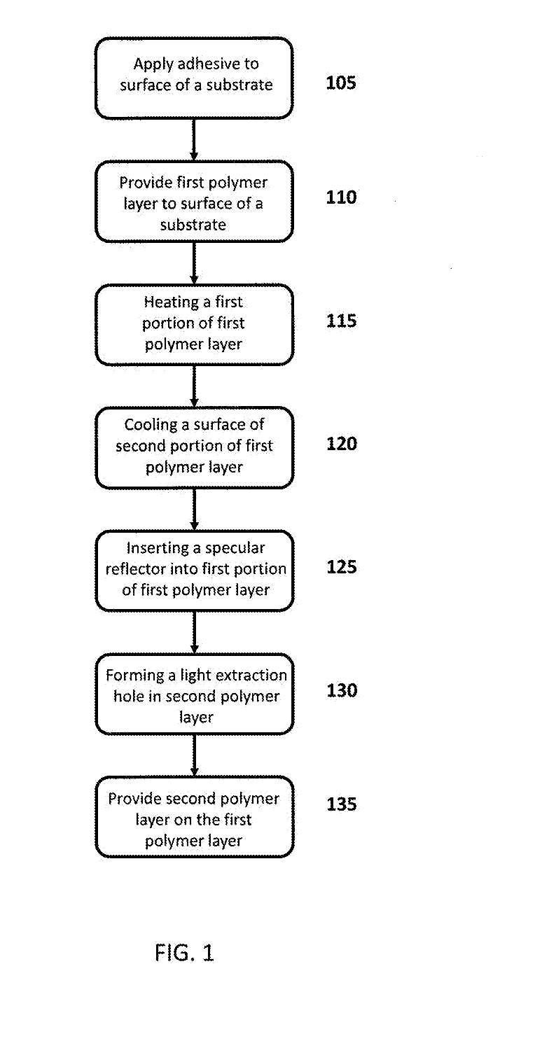

FIG. 1 depicts a flowchart of an illustrative method of forming an optical circuit according to an embodiment. In an embodiment, a method of forming an optical circuit may be simple to perform, inexpensive, and capable of being performed by mass production. In an embodiment, an adhesive may be applied 105 to a surface of a substrate. In some embodiments, the substrate may be a silicon wafer. In other embodiments, the substrate may include a plurality of silicon wafers. In other embodiments, the substrate may be an epoxy fiberglass board. In further embodiments, the substrate may be a plurality of epoxy fiberglass boards. In some embodiments, the adhesive applied 105 to the surface of the substrate may be a polyimide-based adhesive, silicone, acrylamide, epoxy, or any combination thereof. In other embodiments, the adhesive may be a high temperature adhesive. The high temperature adhesive may be silicone.

In some embodiments, a first polymer layer may be provided 110 on the surface of the substrate. The first polymer layer may include a plurality of polymer sublayers. In some embodiments, the first polymer layer is any thermosetting polymer such as, but not limited to, polyester fiberglass, polyurethanes, urea-formaldehyde foam, melamine resin, epoxy resin, polyimide, cyanate esters, polycyanurate, and combinations thereof. In other embodiments, the first polymer layer may be a polyimide. Polyimide material is inexpensive and possesses heat resistant properties.

In some embodiments, the first polymer layer may directly contact the surface of the substrate. In other embodiments, the first polymer layer may be formed directly on the surface of the substrate. In further embodiments, the first polymer layer may be pre-formed and then bonded onto the surface of the substrate. In still further embodiments, the first polymer layer may be produced by chemical vapor deposition to a desired size and thickness, and then bonded onto the surface of the substrate with a high temperature adhesive. The first polymer layer may also be deposited on the substrate using chemical vapor deposition. In some embodiments, providing 110 the first polymer layer may include forming the first polymer layer directly on the surface of the substrate. In other embodiments, providing 110 the first polymer layer may include bonding a pre-formed polymer layer to the surface of the substrate. In other embodiments, providing 110 the first polymer layer may include depositing the first polymer layer on the surface of the substrate using chemical vapor deposition.

In some embodiments, a first portion of the first polymer layer may be heated 115 to a temperature sufficient to increase a refractive index of the first portion such that the refractive index of the first portion is higher than a refractive index of a second portion of the polymer film that at least partially surrounds the first portion. In other embodiments, wherein the first polymer layer is a plurality of sublayers, each sublayer may have a first portion and a second portion. The first portion of the first polymer layer includes the first portion of each sublayer. The heating 115 may include heating 115 the first portion of each sublayer. According to some embodiments, heating 115 a first portion of the first polymer layer may include contacting the first polymer layer with a heated stamp having a temperature of about 300° C. to about 600° C. For example, the heated stamp may have a temperature of about 300° C., about 350° C., about 400° C., about 450° C., about 500° C., about 550° C., about 600° C., or a range between any of these values (including endpoints). In some embodiments, the heating 115 may include heating 115 the first portion of the first polymer layer with an infrared laser. In some embodiments, a heated circuit stamp may be used to impart a pattern of higher refractive index into the first portion of the first polymer layer. The heated stamp may not alter the topology of the first portion of the first polymer layer.

In some embodiments, the first portion of the first polymer layer may have a refractive index of about 1.0 to about 3.0. For example, the refractive index may be about 1.0, about 1.2, about 1.4, about 1.6, about 1.8, about 2.0, about 2.2, about 2.4, about 2.6, about 2.8, about 3.0, or a range between any of these values (including endpoints) after heating. In some embodiments, the first polymer layer may have a refractive index of about 1.5 to about 2.0. The refractive index may be determined by the applied temperature and a time period for which the first polymer layer is heated. A higher temperature may result in a higher refractive index than a lower temperature. Similarly, a longer heating time period may result in higher refractive index than a shorter heating time period. Polyimide materials and/or other materials may experience an increase in a refractive index upon heating. In particular, polyimides may be extremely heat resistant and experience substantial increases in refractive index during heating to temperatures above that of standard reflow temperatures. Unaltered polyimides are transparent to wavelengths above 600 nm, and small modifications to precursors may produce transparency to an increased range of wavelengths without altering other properties.

In some embodiments, a surface of a second portion of the first polymer layer may be cooled 120. In other embodiments, wherein the first polymer layer is a plurality of sublayers, each sublayer may have a first portion and a second portion. The second portion of the first polymer layer includes the second portion of each sublayer. The cooling 120 may include cooling 120 the second portion of each sublayer. In some embodiments, cooling 120 the surface of the second portion of the first polymer layer may be performed after the heating 115 of the first portion of the first polymer layer. In other embodiments, cooling 120 the surface of the second portion of the first polymer layer may be performed at the same time as the heating 115 of the first portion of the first polymer layer.

In some embodiments, a specular reflector may be inserted 125 into the first portion of the first polymer layer. In some embodiments, at least one specular reflector may be provided in the first portion of the first polymer layer at an angle of about 15° to about 60° with respect to the substrate. For example, the angle may be about 15°, about 30°, about 45°, about 50°, about 60°, or an angle in a range between any of these values (including endpoints), with respect to the substrate. In some embodiments, the at least one specular reflector may be provided in the first portion of the first polymer layer at an angle of about 45° with respect to the substrate In some embodiments, the at least one specular reflector may include at least one metallic reflector blade.

In some embodiments, at least one light extraction hole may be formed 130 in the second polymer layer. In other embodiments, at least one light extraction hole may be formed 130 in the second polymer layer before providing the second polymer layer on the first polymer layer, wherein the light extraction hole is substantially aligned over the specular reflector when the second polymer layer is provided on the first polymer layer. In alternate embodiments, at least one light extraction hole may be formed 130 in the second polymer layer after providing the second polymer layer on the first polymer layer, wherein the light extraction hole is substantially aligned over the specular reflector.

In some embodiments, a second polymer layer may be provided 135 on the first polymer layer. In some embodiments, providing 135 the second polymer layer may include bonding the second polymer layer to the first polymer layer. The bonding may be performed at any suitable temperature, such as at a temperature of about 100° C. to about 400° C. For example, the temperature may be about 100° C., about 125° C., about 150° C., about 175° C. about 200° C., about 225° C., about 250° C., about 275° C., about 300° C., about 325° C., about 350° C., about 375° C., about 400° C., or a range between any of these values (including endpoints). In some embodiments, bonding the second polymer layer to the first polymer layer may be carried out at a temperature of about 150° C. to about 350° C. In some embodiments, the first polymer layer and the second polymer layer may be made of the same polymer or polymers. In some embodiments, the second polymer layer may be a polyimide. In some embodiments, both the first polymer layer and the second polymer layer are polyimides.

In other embodiments, one or more integrated circuit (IC) components may be provided on the surface of the substrate. At least a portion of the IC components may be connected by the optical waveguide. In some embodiments, the optical circuit may be a printed circuit board.

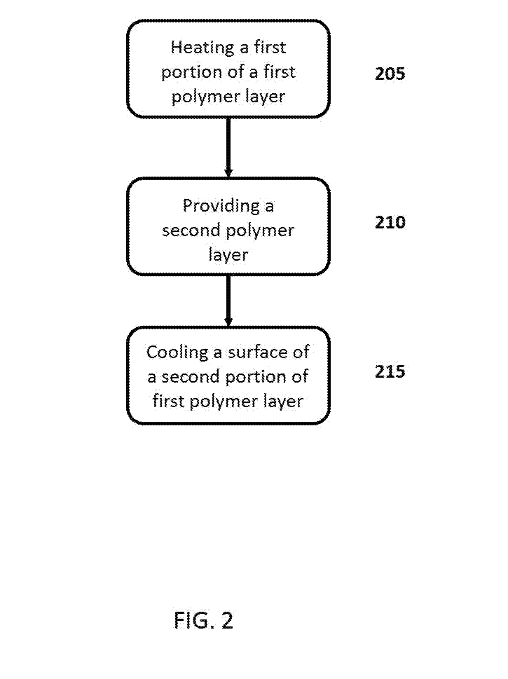

FIG. 2 depicts a flowchart of an illustrative method of making an optical waveguide according to an embodiment. In some embodiments, a first portion of a first polymer layer may be heated 205 to a temperature sufficient to increase a refractive index of the first portion such that the first portion has a higher refractive index than a second portion of the polymer that is at least partially surrounding the first portion. In other embodiments, wherein the first polymer layer is a plurality of sublayers, each sublayer may have a first portion and a second portion. The first portion of the first polymer layer includes the first portion of each sublayer. The heating 205 may include heating 205 the first portion of each sublayer. In some embodiments, heating 205 a first portion of the first polymer layer may include contacting the first polymer layer with a heated stamp. The stamp can be heated to any suitable temperature, such as a temperature of about 300° C. to about 600° C. For example, the temperature may be about 300° C., about 350° C., about 400° C., about 450° C., about 500° C., about 550° C., about 600° C., or a range between any of these values (including endpoints). In other embodiments, the heating 205 may include heating the first portion of the first polymer layer with an infrared laser. In further embodiments, the first portion of the first polymer layer may have a refractive index of about 1.0 to about 3.0. For example, the refractive index may be about 1.0, about 1.2, about 1.4, about 1.6, about 1.8, about 2.0, about 2.2, about 2.4, about 2.6, about 2.8, about 3.0, or a range between any of these values (including endpoints) after heating 205. In some embodiments, the first portion of the first polymer layer may have a refractive index of about 1.5 to about 2.0.

In some embodiments, a second polymer layer may be provided 210. In some embodiments, providing 210 the second polymer layer includes bonding the second polymer layer to the first polymer layer. The bonding can be performed at generally any suitable temperature, such as at a temperature of about 100° C. to about 400° C. For example, the temperature may be about 100° C., about 125° C., about 150° C., about 175° C., about 200° C., about 225° C., about 250° C., about 275° C., about 300° C., about 325° C., about 350° C., about 375° C., about 400° C., or a range between any of these values (including endpoints). In some embodiments, the second polymer layer may be bonded to the first polymer layer at a temperature of about 150° C. to about 350° C. In other embodiments, the second polymer layer may be a polyimide. In some embodiments, the first polymer layer and the second polymer layer may be made of the same polymer or polymers. In further embodiments, both the first polymer layer and the second polymer layer are polyimides.

In some embodiments, a surface of a second portion of the first polymer layer may be cooled 215. In other embodiments, wherein the first polymer layer is a plurality of sublayers, each sublayer may have a first portion and a second portion. The second portion of the first polymer layer includes the second portion of each sublayer. The cooling 215 may include cooling 215 the second portion of each sublayer. In some embodiments, cooling 215 the surface of the second portion of the first polymer layer may be performed after the heating 205 of the first portion of the first polymer layer. In other embodiments, cooling 215 the surface of the second portion of the first polymer layer may be performed at the same time as the heating 205 of the first portion of the first polymer layer.

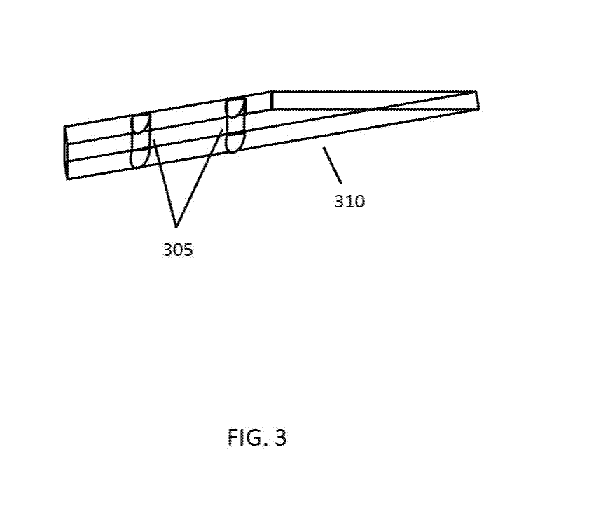

FIG. 3 depicts heat-affected zones 305 within a polymer layer 310 used to form a waveguide according to an embodiment. In some embodiments, the polymer layer 310 may be provided on a surface of a substrate.

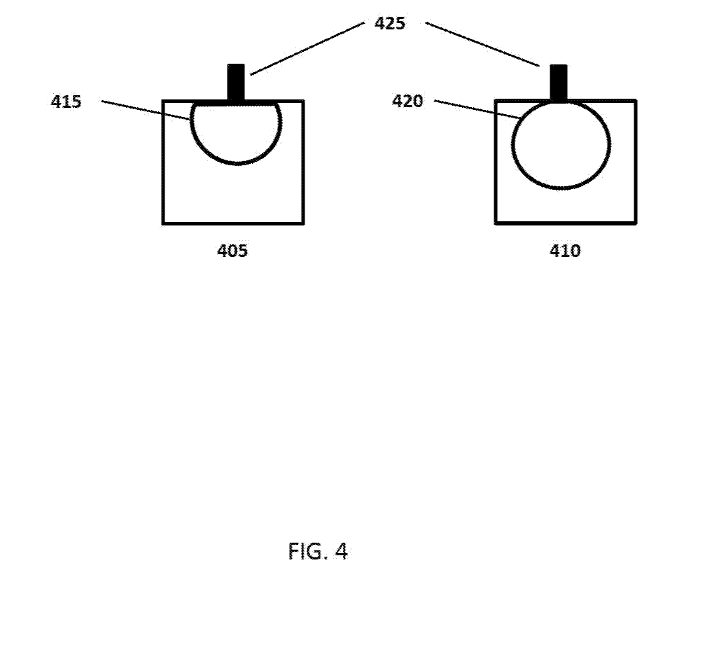

Waveguides with uncooled 405 and cooled surfaces 410 around a heat contact point 425 are illustrated in FIG. 4. In some embodiments, cooling the surface around a heat contact point 425 may cause the cross section of a heat-affected zone 415 to become more circular such as in heat-affected zone 420.

In some embodiments, various methods may be used to form an optical waveguide on consecutive boards. For example, an optical waveguide may be formed using a plate press, continuous rolling, or heated point presses.

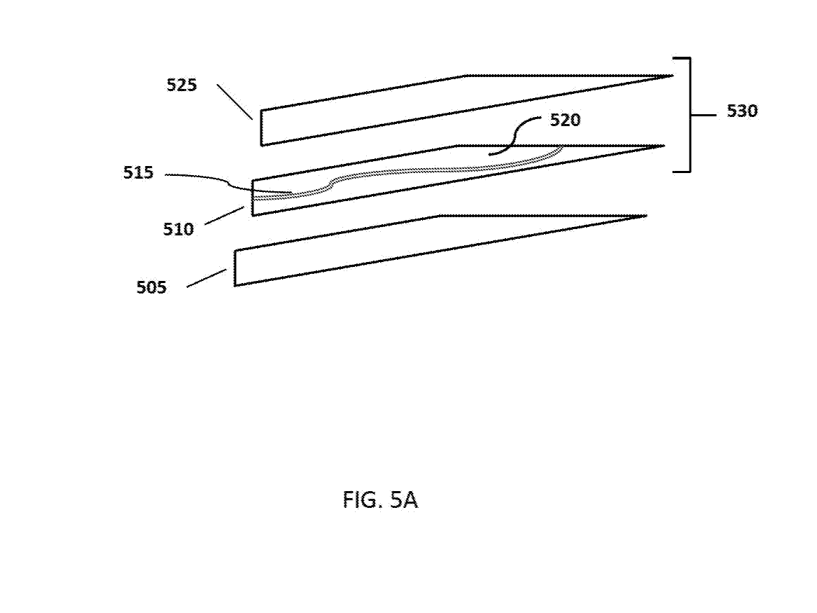

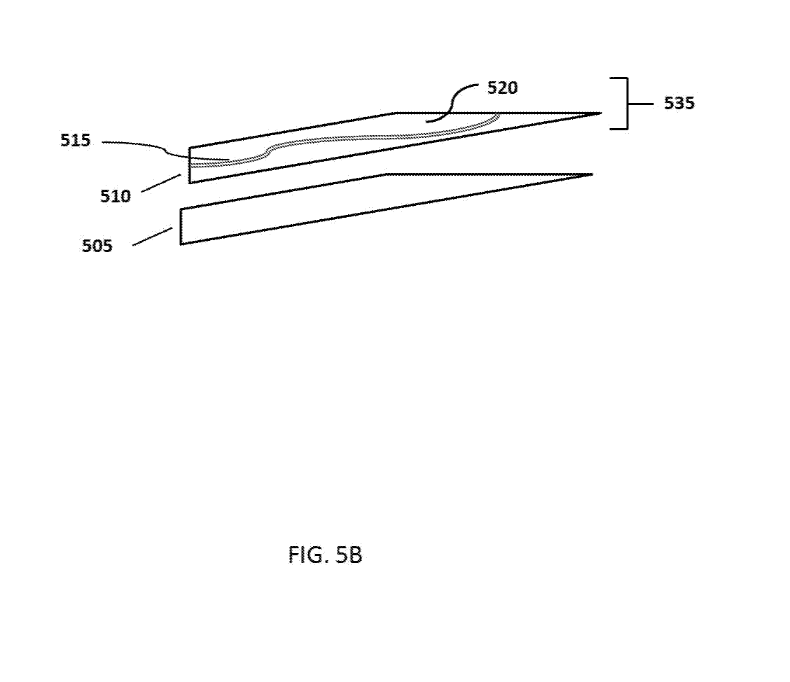

In an embodiment, an optical circuit, such as one manufactured according to the teachings of FIG. 1, may be depicted in FIG. 5A as a substrate 505 having a surface, an optical waveguide 530 having a first polymer layer 510 on the surface of the substrate 505, and a second polymer layer 525 on the first polymer layer 510. The first polymer layer 510 may include a first portion 515 having a higher refractive index than a second portion 520. The second portion 520 may at least partially surround the first portion 515.

In some embodiments, the substrate 505 may be a silicon wafer. In other embodiments, the substrate 505 may include a plurality of silicon wafers. In other embodiments, the substrate 505 may be an epoxy fiberglass board. In further embodiments, the substrate 505 may be a plurality of epoxy fiberglass boards.

In some embodiments, the first polymer layer 510 may be any thermosetting polymer such as, but not limited to, polyester fiberglass, polyurethanes, urea-formaldehyde foam, melamine resin, epoxy resin, polyimide, cyanate esters, polycyanurate, and combinations thereof. In other embodiments, the first polymer layer 510 may be a polyimide. The first polymer layer 510 may include a plurality of polymer sublayers. The plurality of polymer sublayers may be on the surface of the substrate 505. In some embodiments, the plurality of polymer sublayers may be stacked in a direction away from the substrate. In other embodiments, the plurality of polymer sublayers may be placed adjacent to one another.

In further embodiments, the second polymer layer 525 may be a polyimide. In yet further embodiments, both the first polymer layer 510 and the second polymer layer 525 are polyimides.

In some embodiments, the optical circuit may be a printed circuit board. In addition, there may be one or more integrated circuit (IC) components on the surface of the substrate 505. At least a portion of the IC components may be connected by the optical waveguide 530.

In some embodiments, the first polymer layer 510 may directly contact the surface of the substrate 505. In other embodiments, there may be an adhesive between the surface of the substrate 505 and the first polymer layer 510. In some embodiments, the adhesive directly contacts the surface of the substrate 505 and also directly contacts the first polymer layer 510. In some embodiments, the adhesive may be a polyimide-based adhesive, silicone, acrylamide, epoxy, or any combination thereof. In other embodiments, the second polymer layer 525 may be bonded to the first polymer layer 510.

The optical circuit may have uniform thicknesses or varying thicknesses for the first polymer layer 510 and/or the second polymer layer 525. In some embodiments, the second polymer layer 525 may have a thickness of about 1 micrometer to about 300 micrometers. For example, the thickness may be about 1 micrometer, about 25 micrometers, about 50 micrometers, about 75 micrometers, about 100 micrometers, about 125 micrometers, about 150 micrometers, about 175 micrometers, about 200 micrometers, about 225 micrometers, about 250 micrometers, about 275 micrometers, about 300 micrometers, or a range between any of these values (including endpoints). In some embodiments, the second polymer layer 525 may have a thickness of less than or equal to about 300 micrometers. In some embodiments, the second polymer layer 525 may have a thickness of about 50 micrometers to about 250 micrometers. In some embodiments, the second polymer layer 525 may have a thickness of about 100 micrometers to about 200 micrometers. In other embodiments, a combination of the two thicknesses of the first and second polymer layers 510, 525 is about 300 micrometers to about 1.5 millimeters. For example, the combination of the two thicknesses may be about 300 micrometers, about 400 micrometers, about 500 micrometers, about 600 micrometers, about 700 micrometers, about 800 micrometers, about 900 micrometers, about 1.0 millimeter, about 1.1 millimeters, about 1.2 millimeters, about 1.3 millimeters, about 1.4 millimeters, about 1.5 millimeters, or a range between any of these values (including endpoints). In some embodiments, the combination of the two thicknesses may be about 500 micrometers to about 1 millimeter.

In some embodiments, the first portion 515 of the first polymer layer 510 may have a refractive index of about 1.0 to about 3.0. For example, the refractive index may be about 1.0, about 1.2, about 1.4, about 1.6, about 1.8, about 2.0, about 2.2, about 2.4, about 2.6, about 2.8, about 3.0, or a range between any of these values (including endpoints). In some embodiments, the refractive index may be about 1.5 to about 2.0.

The optical waveguide 530 may also have varying depths. For example, the optical waveguide 530 may have a depth of about 1 micrometer to about 400 micrometers. For example, the depth may be about 1 micrometer, about 50 micrometers, about 100 micrometers, about 150 micrometers, about 200 micrometers, about 250 micrometers, about 300 micrometers, about 350 micrometers, about 400 micrometers, or a range between any of these values (including endpoints). In some embodiments, the optical waveguide 530 may have a depth of about 1 micrometer to about 200 micrometers. In some embodiments, the optical waveguide 530 may have a depth of about 1 micrometer to about 100 micrometer.

Additionally, the optical waveguide 530 may have at least one specular reflector. The specular reflector may be at an angle of about 15° to about 60° with respect to the substrate 505. For example, the angle may be about 15°, about 30°, about 45°, about 50°, about 60°, or an angle in a range between any of these values (including endpoints). In some embodiments, the specular reflector may be at an angle of about 45° with respect to the substrate 505. In some embodiments, the specular reflector may be at least one metallic reflector blade. In other embodiments, the specular reflector may be a plurality of metallic reflector blades. In further embodiments, the second polymer layer 525 may have one or more light extraction holes substantially aligned above the specular reflector.

Various embodiments are directed to an optical waveguide. In an embodiment, an optical waveguide, such as one made in accordance with the teachings of FIG. 2, may be depicted as in FIG. 5B. In some embodiments, an optical waveguide 535 may have a first polymer layer 510 on a surface of a substrate 505. In other embodiments, a second polymer layer 525 may be added onto the first polymer layer 510. The first polymer layer 510 may comprise a first portion 515 with a higher refractive index than a second portion 520. The second portion 520 may at least partially surround the first portion 515.

In some embodiments, the substrate may be a silicon wafer. In other embodiments, the substrate 505 may comprise a plurality of silicon wafers. In other embodiments, the substrate 505 may be an epoxy fiberglass board. In further embodiments, the substrate 505 may be a plurality of epoxy fiberglass boards.

In some embodiments, the first polymer layer 510 may be any thermosetting polymer such as, but not limited to, polyester fiberglass, polyurethanes, urea-formaldehyde foam, melamine resin, epoxy resin, polyimide, cyanate esters, polycyanurate, and combinations thereof. In other embodiments, the first polymer layer 510 may be a polyimide. The first polymer layer 510 may include a plurality of polymer sublayers. The plurality of polymer sublayers may be on the surface of the substrate 505. In some embodiments, the plurality of polymer sublayers may be stacked in a direction away from the substrate. In other embodiments, the plurality of polymer sublayers may be placed adjacent to one another.

In further embodiments, the second polymer layer 525 may be a polyimide. In yet further embodiments, both the first polymer layer 510 and the second polymer layer 525 are polyimides.

The optical waveguide may have varying thicknesses for the first polymer layer 510 and/or the second polymer layer 525. In some embodiments, the second polymer layer 525 may have a thickness of about 1 micrometer to about 300 micrometers. For example, the thickness may be about 1 micrometer, about 25 micrometers, about 50 micrometers, about 75 micrometers, about 100 micrometers, about 125 micrometers, about 150 micrometers, about 175 micrometers, about 200 micrometers, about 225 micrometers, about 250 micrometers, about 275 micrometers, about 300 micrometers, or a range between any of these values (including endpoints). In some embodiments, the second polymer layer 525 may have a thickness of less than or equal to about 300 micrometers. In some embodiments, the second polymer layer 525 may have a thickness of about 50 micrometers to about 250 micrometers. In some embodiments, the second polymer layer 525 may have a thickness of about 100 micrometers to about 200 micrometers. In other embodiments, a combination of the two thicknesses of the first and second polymer layers 510, 525 is about 300 micrometers to about 1.5 millimeters. For example, the combination of the two thicknesses may be about 300 micrometers, about 400 micrometers, about 500 micrometers, about 600 micrometers, about 700 micrometers, about 800 micrometers, about 900 micrometers, about 1.0 millimeter, about 1.1 millimeters, about 1.2 millimeters, about 1.3 millimeters, about 1.4 millimeters, about 1.5 millimeters, or a range between any of these values (including endpoints). In some embodiments, the combination of the two thicknesses may be about 500 micrometers to about 1 millimeter.

In some embodiments, the first portion 515 of the first polymer layer 510 may have a refractive index of about 1.0 to about 3.0. For example, the refractive index may be about 1.0, about 1.2, about 1.4, about 1.6, about 1.8, about 2.0, about 2.2, about 2.4, about 2.6, about 2.8, about 3.0, or a range between any of these values (including endpoints). In some embodiments, the refractive index may be about 1.5 to about 2.0.

The optical waveguide 535 may also have varying depths. For example, the optical waveguide 535 may have a depth of about 1 micrometer to about 400 micrometers. For example, the depth may be about 1 micrometer, about 50 micrometers, about 100 micrometers, about 150 micrometers, about 200 micrometers, about 250 micrometers, about 300 micrometers, about 350 micrometers, about 400 micrometers, or a range between any of these values (including endpoints). In some embodiments, the optical waveguide 535 may have a depth of about 1 micrometer to about 200 micrometers. In some embodiments, the optical waveguide 535 may have a depth of about 1 micrometer to about 100 micrometer.

Additionally, the optical waveguide may have at least one specular reflector. The specular reflector may be at an angle of about 15° to about 60° with respect to the substrate 505. For example, the angle may be about 15°, about 30°, about 45°, about 50°, about 60°, or an angle in a range between any of these values (including endpoints). In some embodiments, the specular reflector may be at an angle of about 45° with respect to the substrate 505. In some embodiments, the specular reflector may be at least one metallic reflector blade. In other embodiments, the specular reflector may be a plurality of metallic reflector blades. In further embodiments, the second polymer layer 525 may have one or more light extraction holes substantially aligned above the specular reflector.

### EXAMPLES

### Example 1

### A Method of Making a Thermally Printed Optical Circuit

An acrylamide adhesive will be applied to the surface of a silicon wafer. A first layer of thermosetting polyimide will be applied to the surface of a silicon wafer that has the acrylamide adhesive. The first layer of thermosetting polyimide will be heated to a temperature of 450° C., while simultaneously cooling a surrounding portion of the thermosetting polyimide layer. These combined steps will create a first portion of the thermosetting polyimide layer that will have an increased density as compared to a second portion of the thermosetting polyimide layer. The increased density will result in the first portion of the thermosetting polyimide layer having a refractive index of 1.5. Two metallic specular reflector blades will be inserted into the first portion of the thermosetting polyimide layer. Two light extraction holes will be formed in a second polyimide layer. This second polyimide layer will be added on top of the first polyimide layer in a position where the two light extraction holes will be aligned directly over the two metallic specular reflector blades.

A component utilizing this waveguide system will be equipped with an optical emitter and detector at the second polyimide layer. The component will have power delivered by a simple power delivery circuit etched onto the surface of the optical board, which will power these optical elements. The component will send information to a similarly equipped component. The information will be converted to an optical signal and will be produced by an emitter element, propagating the length of the waveguide until it reaches a detector element. The information will then be converted to an electronic signal to be processed.

This thermally printed optical circuit will provide faster data transmission over chip-to-chip and greater distances, increased stability due to higher capacity and advanced wavelength multiplexing, lower power requirements, less waste heat, and easier direct compatibility with long range optical communication methods.

### Example 2

### A Thermosetting Polyimide Waveguide

A film of un-aged thermosetting polyimide will be applied to the surface of an epoxy fiberglass circuit board using chemical vapor deposition. The thermosetting polyimide will be heated to a temperature of 400° C., resulting in a first portion of the thermosetting polyimide having a refractive index of 1.4 and a second portion of the thermosetting polyimide surrounding the first portion. A pre-determined waveguide pattern will be implanted in a single step by a pre-made stamp heated to a temperature of 350° C. A second film layer of the same thermosetting polyimide will be adhered on top of the first film layer of thermosetting polyimide with a silicone adhesive.

This waveguide will have simpler manufacturing than traditional waveguides and will have the ability to be integrated into existing manufacturing methods.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and one or more to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases one or more or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of forming an optical circuit, the method comprising:
providing a first polymer layer on a surface of a substrate;
heating a first portion of the first polymer layer to a temperature sufficient to increase a refractive index of the first portion such that the first portion has a higher refractive index relative to a second portion of the first polymer film, the second portion at least partially surrounding the first portion to form an optical waveguide; and
providing a second polymer layer on the first polymer layer.

2. (canceled)

3. The method of claim 1, further comprising providing one or more integrated circuit (IC) components on the surface of the substrate, wherein at least a portion of the IC components are connected by the optical waveguide.

4. The method of claim 1, wherein providing the second polymer layer comprises bonding the second polymer layer to the first polymer layer at a temperature of about 150° C. to about 350° C.

5. The method of claim 1, wherein providing the first polymer layer comprises one or more of forming the first polymer layer directly on the surface of the substrate, bonding a pre-formed polymer layer to the surface of the substrate and depositing the first polymer layer on the surface of the substrate using chemical vapor deposition.

6.-7. (canceled)

8. The method of claim 1, wherein providing a first polymer layer comprises providing a first polymer layer on a substrate including a silicon wafer.

9. (canceled)

10. The method of claim 1, wherein providing a first polymer layer comprises providing a first polymer layer including a thermosetting polymer selected from a group consisting of polyester fiberglass, polyurethanes, urea-formaldehyde foam, melamine resin, epoxy resin, polyimide, cyanate esters, polycyanurate, and combinations thereof.

11. The method of claim 1, wherein providing a first polymer layer comprises providing a first polymer layer including a polyimide and providing a second polymer layer comprises providing a second polymer layer including a polyimide.

12.-13. (canceled)

14. The method of claim 1, further comprising applying an adhesive to the surface of the substrate prior to providing the first polymer layer.

15. (canceled)

16. The method of claim 1, wherein the heating comprises contacting the first polymer layer with a heated stamp having a temperature of about 300° C. to about 600° C.

17. (canceled)

18. The method of claim 1, wherein the heating a first portion comprises heating a first portion to a temperature sufficient to obtain a refractive index of about 1.5 to about 2.0.

19. (canceled)

20. The method of claim 1, further comprising inserting at least one specular reflector into the first portion of the first polymer layer after heating.

21. The method of claim 1, further comprising inserting at least one specular reflector into the first portion of the first polymer layer at an angle of about 45° with respect to the substrate.

22. (canceled)

23. The method of claim 20, further comprising:
forming at least one light extraction hole in the second polymer layer; and
aligning the light extraction hole over the specular reflector.

24. (canceled)

25. An optical circuit comprising:
a substrate having a surface;
an optical waveguide comprising a first polymer layer on the surface of the substrate, the first polymer layer comprising a first portion having a higher refractive index than a second portion, the second portion at least partially surrounding the first portion; and
a second polymer layer on the first polymer layer.

26. The optical circuit of claim 25, wherein the optical circuit is a printed circuit board.

27. The optical circuit of claim 25, wherein the optical circuit further comprises one or more integrated circuit (IC) components on the surface of the substrate, wherein at least a portion of the IC components are connected by the optical waveguide.

28. The optical circuit of claim 25, wherein the second polymer layer is bonded to the first polymer layer.

29. (canceled)

30. The optical circuit of claim 25, wherein the first polymer layer comprises a plurality of polymer sublayers.

31. The optical circuit of claim 25, wherein the substrate is a silicon wafer.

32. (canceled)

33. The optical circuit of claim 25, wherein the first polymer layer is a thermosetting polymer selected from a group consisting of polyester fiberglass, polyurethanes, urea-formaldehyde foam, melamine resin, epoxy resin, polyimide, cyanate esters, polycyanurate, and combinations thereof.

34. The optical circuit of claim 25, wherein one or more of the first polymer layer and the second polymer layer include a polyimide.

35.-36. (canceled)

37. The optical circuit of claim 25, further comprising an adhesive between the surface of the substrate and the first polymer layer.

38. (canceled)

39. The optical circuit of claim 25, wherein the second polymer layer has a thickness of less than or equal to about 300 micrometers.

40.-41. (canceled)

42. The optical circuit of claim 25, wherein a combined thicknesses of the first polymer layer and the second polymer layer is about 500 micrometers to about 1 millimeter.

43. The optical circuit of claim 25, wherein the optical waveguide has a depth of about 1 micrometer to about 200 micrometers.

44. (canceled)

45. The optical circuit of claim 25, wherein the first portion of the first polymer layer has a refractive index of about 1.5 to about 2.0.

46. The optical circuit of claim 25, wherein the optical waveguide further comprises at least one specular reflector set at an angle of about 45° with respect to the substrate.

47. (canceled)

48. The optical circuit of claim 46, wherein the at least one specular reflector comprises at least one metallic reflector blade.

49. The optical circuit of claim 46, wherein the second polymer layer comprises one or more light extraction holes substantially aligned above the specular reflector.

50.-77. (canceled)
